(19) United States
(12) Patent Application Publication
(10) Pub. No.: US 2008/0248436 A1
(43) Pub. Date: Oct. 9, 2008

(54) METHOD OF FILLING LARGE VOIDS WITH CERAMIC FIBER FOAM AND KILN CAR BLOCKS MADE VIA THE SAME

(76) Inventor: David Erhardt, Newburgh, IN (US)

Correspondence Address: Brannon & Associates PC, 1 North Pennsylvania Street, Suite 520, Indianapolis, IN, 46204, US

(21) Appl. No.: 12/062,979

(22) Filed: Apr. 4, 2008

Related U.S. Application Data
(60) Provisional application No. 60/910,033, filed on Apr. 4, 2007.

(51) Int. Cl. C04B 41/00; F27D 3/12

(52) U.S. Cl. 432/241; 501/84

(57) ABSTRACT

A method of filling cavities in refractory bodies, comprising lofting refractory fibers in flowing air, mixing lofted refractory fibers with refractory foam to generate a fibrous refractory foam, and filling a substantially enclosed cavity in a refractory material with fibrous refractory foam to produce a foam-filled cavity, heating the foam-filled cavity to a first drying temperature for sufficient time to dry the fibrous refractory foam filling, and heating the foam-filled cavity to a second substantially higher firing temperature to produce a fired body. The substantially enclosed cavity is defined by at least one refractory wall.

### CROSS-REFERENCE TO RELATED APPLICATIONS

This application claims priority to co-pending U.S. Provisional Patent Application Ser. No. 60/910033, filed Apr. 4, 2007.

### TECHNICAL FIELD

The novel technology relates generally to the materials science, and, more particularly, to a method for controlling the distribution of fibrous insulation filling voids or enclosures in ceramic, cermet, like or refractory bodies.

### BACKGROUND

Many ceramic bodies are made with inherent relatively large scale cavities or open spaces. This may be done for a variety of reasons, such as to keep weight down for shipping, to conserve materials, or to leave space for the addition of a second composition with different properties. In the case of kiln car blocks, relatively large void spaces are intentionally formed for the later insertion of fibrous insulation. This insulation is usually provided in the form of sheets, blankets or bulk fiber material and is typically inserted by hand. The insertion process is thus labor intensive, time consuming, and inherently inconsistent, adding expense and time and resulting in an unevenly insulated final product. Thus, there is a need for a means of quickly and uniformly filling the void spaces formed in ceramic bodies, such as kiln cars, with fibrous material. The novel technology discussed herein addresses this need.

### SUMMARY

The present novel technology relates generally to the field of ceramic engineering and, more particularly, to a method of filling relatively large voids in preformed ceramic bodies with pumpable fibrous foam. One object of the present novel technology is to provide an improved system for filling voids in thin-walled ceramic bodies. Related objects and advantages of the present novel technology will be apparent from the following description.

### BRIEF DESCRIPTION OF THE DRAWINGS

FIG. 1 is a schematic perspective view of a prior art nozzle for mixing foamed material with lofted fibrous insulation.

FIG. 2 is a sectional view of the prior art nozzle of FIG. 1.

FIG. 3 is a diagrammatic representatuon of a method for filling kiln car cavities according to a first embodiment of the novel technology.

FIG. 4 is a schematic representation of a fibrous foam injection assembly according to a second embodiment of the present novel technology.

FIG. 5 is a first perspective view of voids filled according to a first embodiment of the present novel technology.

FIG. 6 is a second perspective view of voids filled according to a first embodiment of the present novel technology.

FIG. 7 is a first enlarged perspective view of voids filled according to a first embodiment of the present novel technology.

FIG. 8 is a second enlarged perspective view of voids filled according to a first embodiment of the present novel technology.

### DETAILED DESCRIPTION OF THE PREFERRED EMBODIMENT

For the purposes of promoting an understanding of the principles of the novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

According to one embodiment, the present novel technology relates to a method 5 of filling relatively large or macroscale voids or openings 10 in ceramic or like bodies 15, such as the 3″ by 3″ by 18″ voids formed in kiln car blocks, with foamed fibrous material 20. The fibers 25 infiltrating the foam 20 are typically refractory, and, more typically, substantially ceramic in nature.

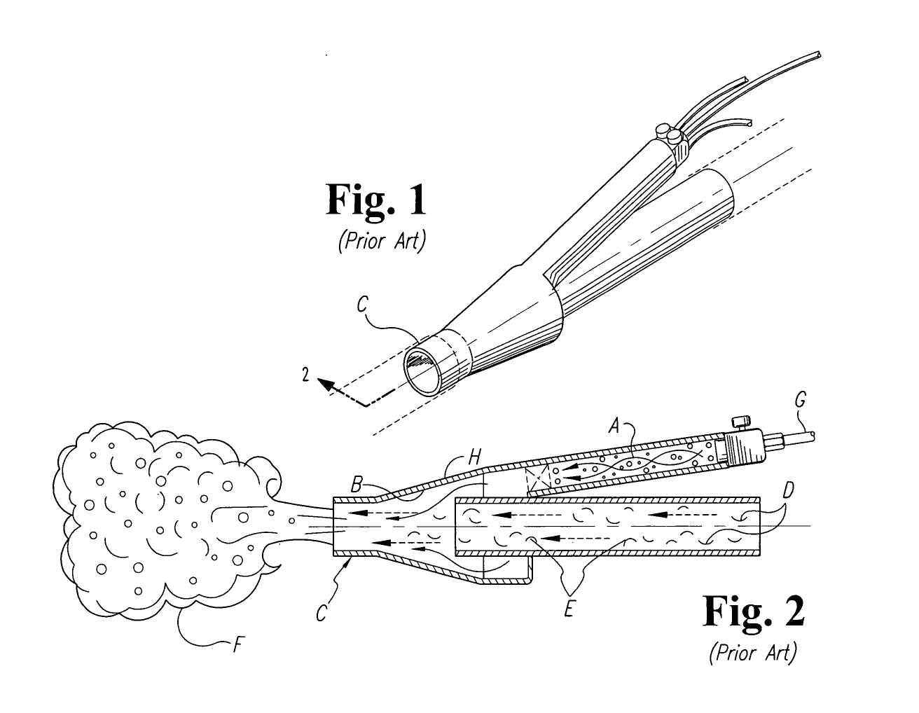

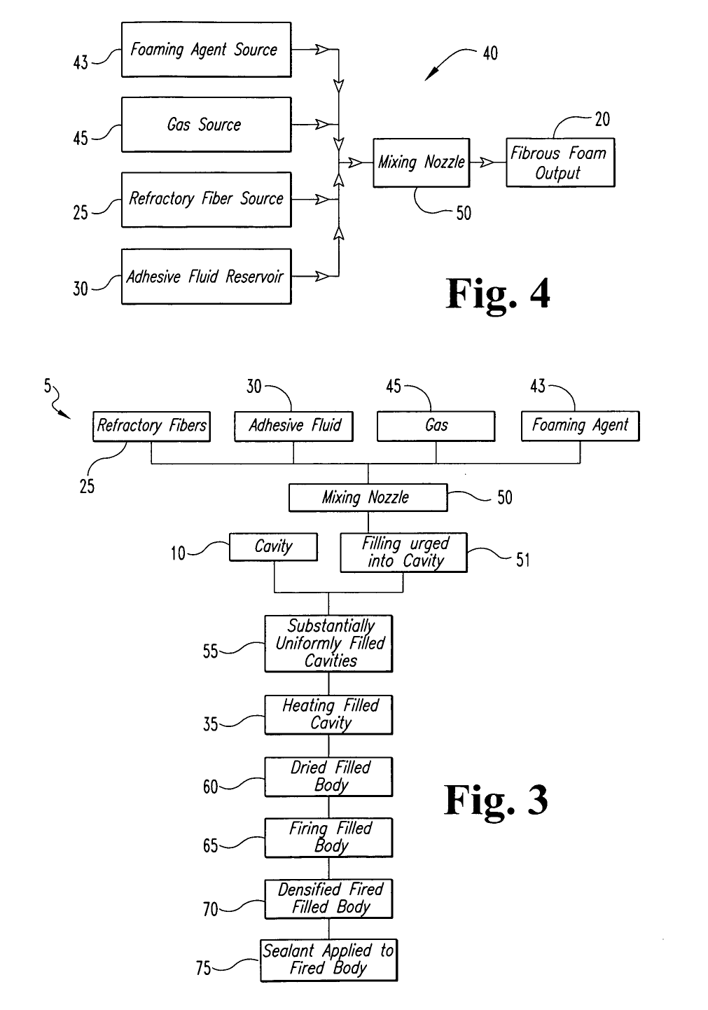

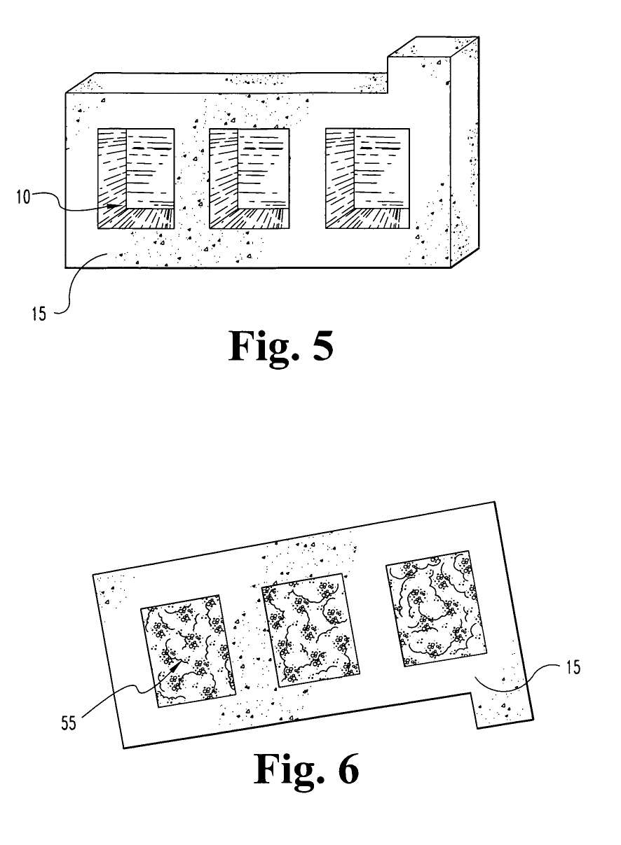

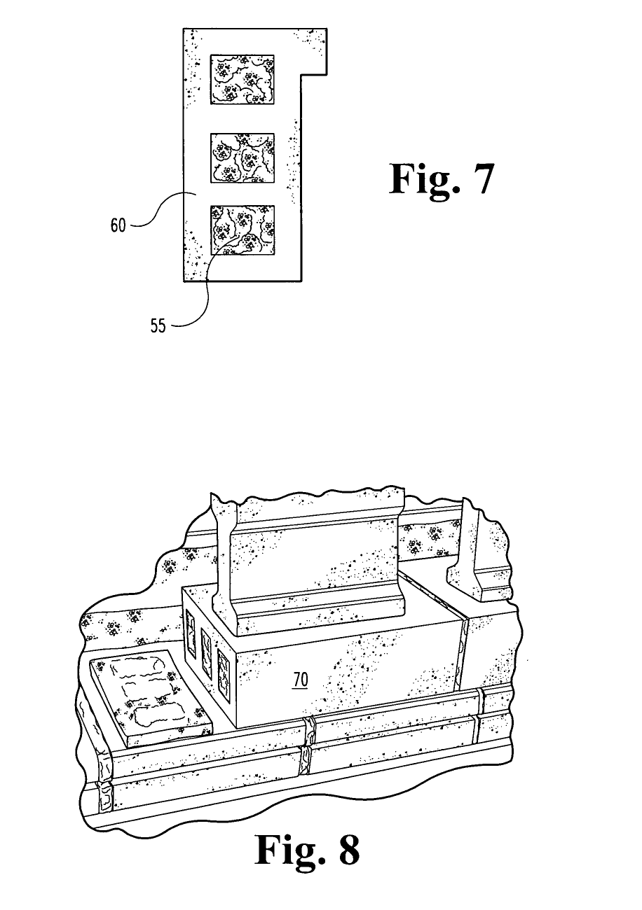

As is known in the art and illustrated schematically in FIGS. 1 and 2, fibrous foam may be produced by mixing a foaming agent with pressurized air to create a foam A, which may then be introduced into a mixing chamber B of a nozzle C. Substantially dry fibrous particles D are mixed with the pressurized air to produce lofted fibers E. The lofted fibers E are likewise introduced into the mixing chamber B of the nozzle C. In the mixing chamber B, the lofted fibers E are mixed with the foamed material A to create a fibrous foam F, wherein the foam A maintains the loft or the desired spreading of the insulation fibers D relative to each other. The mixture of fibers and foamed material F is forced under pressure away from the nozzle C and the foam material F continues to maintain the desired loft or spreading of the fibers D during the ejection of the mixture F towards a desired space. The fibrous foam mixture F is received in the desired space where the foam F continues to maintain the desired loft or spreading of the insulation fibers D to achieve uniformity of the insulation. Because of the presence of the foam A, the lofted fibers E in the desired space are able to withstand the impact from subsequent application of the mixture F and are able to maintain the loft or separation of fibers in spite of the weight of insulation material above.

Preferably, the foamed material F includes an amount of adhesive G. After the mixture F has been sprayed into the desired space, the adhesive material G, after drying, acts to maintain the loft or separation of fibers D even when the foam or liquid portion A dries or dissipates. In this way, the dried blown-in insulation maintains its insulation capacity by virtue of the fibers D present rather than depending on continued presence of foam A. The foam A also acts to spread the adhesive G for desired mixing with the fibers D.

With regard to the nozzle C itself, the nozzle C includes a conduit H that carries the foamed material F and which tapers at the nozzle portion C where the mixing of the fibers E and foamed material A occurs. This configuration is important in preventing back flow of material F into the conduit H, particularly whenever the flow of materials F is discontinued for a time by shutting off the pressurized air.

Fibrous foam in the known art has been used to fill relatively large volumes such as wall forms, floor and ceiling forms, and the like. These large, open forms are filled with foam to form relatively high-volume bodies. Alternately, fibrous foam has been sprayed as a coating directly onto refractory or like surfaces. In contrast, the cavities or enclosures addressed by the novel technology define a much higher surface area-to-volume ratio and present unique challenges to filling with foamed insulation.

For instance, kiln car cavities 10 are currently stuffed by hand with ceramic bulk fiber, resulting in uneven filling of the cavities. Uneven filling of the cavities 10 yields uneven thermal insulation, higher fuel consumption, and uneven heating of product in the kiln, which in turn means decreased efficiency and more unusable or defective product produced. Hand-filling also generates a relatively great amount of potentially hazardous fiber dust exposure to workers packing the cavities.

Kiln car cavities 10 may also be filled with fiber blanket material cut to shape to fill the cavities 10. While cutting down on the production of fiber dust over the hand-stuffing technique described above, such fiber blanket packing of cavities 10 is still prone to uneven packing and thermal insulation. In addition, fiber blanket material is likewise prone to dislodgment and easily falls out of the cavity if the filled body is moved or jostled.

These problems are addressed by the present novel technology, a method 5 by which the relatively high surface area-to-volume cavities/enclosures 10 (as contrasted with the large volume preforms traditionally filled with foam) are quickly and evenly filled with flowing fibrous foam. After the cavities 10 have been filled, the foam filling 55 is allowed to dry. Drying may be done at ambient temperatures, at slightly elevated drying temperatures (such as by heating 35 to a drying temperature of about 100 degrees Celsius), or by introducing the filled body directly into a high temperature environment, such as a fired kiln.

In operation and as described above regarding the prior art, the foam dispensing apparatus 40 includes a foaming agent source 43 and a pressurized gas source 45 (typically air) both pneumatically connected to a mixing nozzle 50. The foaming agent source 43 typically provides colloidal silica, colloidal alumina, a mixture of the two, or the like. A source of refractory fibers 25 is typically operationally connected to the mixing nozzle 50, such that lofted fibers 25 are substantially homogenously intermixed with the refractory foam 43.

Optionally, a source of adhesive fluid 30 is connected to the nozzle 50, such that the adhesive fluid 30 (if present) is mixed with the fibrous foaming agent 20 by pressurized air flowing through the nozzle 50; likewise, the fibers 25 are mixed with the foam 43 to produce a fibrous foam output 20. The adhesive fluid 30 is typically colloidal silica, colloidal alumina or the like. The fibrous foam 20 is then directed and urged 51 into the typically substantially enclosed cavities 10 present in a body 15 to produce a substantially uniform filling 55.

The foam filling 55 is typically characterized by a cellular structure, which may be open or closed cell. The foam filling 55 is then dried in situ. Such drying may occur at ambient temperature, or may be accelerated, such as by heating 35 the filling 55 to a drying temperature or temperature range, typically between about 85 and about 130 degrees Celsius. During drying, the foaming agent matrix material 43 solidifies and holds the fibers 25 in place; the foam matrix 43 and any added adhesive material 30 also begin to bond with the cavity walls, holding the filling 55 in place. Further, the highly permeable open porosity of the filling 55 allows for rapid removal of water and other volatiles, such that a newly formed filling 55 may be introduced directly into a fired environment without structural damage occurring from the rapid evolution of water vapor and/or other gasses.

Once the filling 55 been formed (and optionally, has remained at the drying temperature for sufficient time for the filling 55 to dry, i.e., moisture and/or solvent and/or volatiles to be removed), the filled 55 body or dried filled body 60 may then be shipped and used for its intended purpose. Optionally, the body 60 may be fired 65 to a substantially higher temperature to yield a fired body 70.

Optionally, a sealant 75 may be applied to any exposed filling 55 after the drying 35 or firing 65 step, as a method for controlling colloidal silica and/or colloidal alumina migration, as well as sealing of any open surface porosity to prevent or retard moisture uptake and like infiltration of unwanted materials.

The so-filled bodies 70 exhibit a more uniform filling density (typically about 8 pounds per cubic foot) with substantially less variance than do the hand-packed bodies of the prior art. Moreover, in addition to being more uniform, the filling process 5 is much quicker and far less manpower intensive, yielding filled bodies 70 that are much more robust for shipping and handling.

While the novel technology has been illustrated and described in detail in the drawings and foregoing description, the same is to be considered as illustrative and not restrictive in character, it being understood that only the preferred embodiment has been shown and described and that all changes and modifications that come within the spirit of the novel technology are desired to be protected.

I claim:

1. A method of filling cavities in refractory bodies, comprising:
a) lofting refractory fibers in flowing air;
b) mixing lofted refractory fibers with refractory foam to generate a fibrous refractory foam;
c) filling a substantially enclosed cavity in a refractory material with fibrous refractory foam to produce a foam-filled cavity, wherein the substantially enclosed cavity is defined by at least one refractory wall;
d) drying the foam-filled cavity in a first drying temperature range for sufficient time to dry the fibrous refractory foam filling;
e) heating the foam-filled cavity to a second substantially higher firing temperature to produce a fired body.

2. The method of claim 1 and further comprising:
f) after b and before c, mixing an adhesive with the refractory foam;
g) after c and before d, adhering the refractory foam filling to the at least one refractory wall.

3. The method of claim 1 wherein the refractory foam filling is bonded to the at least one refractory wall.

4. A method for filling an enclosure in a refractory kiln car body, comprising:
a) lofting refractory fibers;
b) mixing lofted refractory fibers with a refractory foam to yield a fibrous foam composition defined by refractory fibers substantially homogeneously distributed in a refractory foam matrix;
c) mixing an adhesive liquid with the fibrous foam composition;
d) filling an enclosure in a refractory kiln car body with fibrous refractory foam to define a foam-filled enclosure, wherein the enclosure is defined by at least one refractory wall;
e) adhering the foam to the refractory wall; and
f) drying the foam-filled enclosure at a first drying temperature;
wherein after f), the at least one refractory wall is substantially in contact with foam filling.

5. The method of claim 4 wherein the adhesive liquid is selected from the group including colloidal silica, colloidal alumina, and mixtures thereof.

6. The method of claim 4 and further comprising:
g) firing the foam-filled cavity at a second substantially higher firing temperature to yield a kiln car body with fired fibrous foam filled cavities;

7. The method of claim 6 wherein after g), the foam filling is at least partially bonded to the at least one refractory wall.

8. The method of claim 4 wherein the fibers are substantially evenly distributed in the fired fibrous foam filled cavities.

9. The method of claim 4 wherein the foam filling is substantially homogeneous.

10. A method for filling a refractory enclosure, comprising:
a) lofting refractory fibers;
b) mixing lofted refractory fibers with an adhesive and a refractory foam to yield a fibrous refractory foam:
c) filling an enclosure in a refractory body with fibrous refractory foam to define a foam-filled enclosure, wherein the enclosure is defined by at least one refractory wall and the foam filling defines an exposed surface portion;
d) adhering the foam filling to the refractory wall; and
e) bonding the foam filling to the refractory wall.

11. The method of claim 10 wherein e) is performed at an elevated temperature.

12. The method of claim 10 wherein at least one of the respective adhesive and refractory foam contains colloidal silica, colloidal alumina, or a mixture thereof.

13. The method of claim 10 wherein the foam filled enclosure defines a substantially homogeneous fiber distribution in a foam matrix.

14. The method of claim 10 and further comprising:
f) applying a sealant to the exposed surface portion.

15. A kiln car body, comprising:
a refractory kiln car body;
at least one cavity formed in the refractory body;
fibrous foam filling the at least one cavity;
wherein the fibrous foam further comprises:
a cellular ceramic matrix; and
a plurality of ceramic fibers substantially uniformly distributed in the cellular ceramic matrix; and
wherein the fibrous foam is bonded to the refractory kiln car body.

16. The kiln car body of claim 15 wherein the cellular ceramic matrix is selected from the group including foamed colloidal silica, foamed colloidal alumina and mixtures thereof.

17. The kiln car body of claim 15 wherein the fibrous foam is characterized by an open cell structure.

18. The kiln car body of claim 17 wherein the kiln car body further comprises a sealant layer substantially covering the fibrous foam filling.
